(19) United States
(12) Patent Application Publication
(10) Pub. No.: US 2003/0096610 A1
(43) Pub. Date: May 22, 2003

(54) System and method for allocating communication resources within a hub and spoke network of a communication platform

(76) Inventors: William F. Courtney, Long Beach, CA (US); Richard L. Vogel, Palos Verdes Estates, CA (US); Ray m. Nuber, Rancho Palos Verdes, CA (US); Christopher E. Kelly, Manhattan Beach, CA (US)

Correspondence Address: PATENT COUNSEL, TRW INC., S & E LAW DEPT., ONE SPACE PARK, BLDG. E2/6051, REDONDO BEACH, CA, 90278, US

(21) Appl. No.: 09/991,203

(22) Filed: Nov. 20, 2001

(51) Int. Cl. H04B 7/185

(52) U.S. Cl. 455/429; 455/452; 455/13.3

(57) ABSTRACT

A system and method for allocating uplink and downlink bandwidth in a communication system is presented. The communication system includes a communication platform, a plurality of spokes and at least one hub. The plurality of spokes and at least one hub communicate through the communication platform. Each spoke includes spoke uplink bandwidth and spoke downlink bandwidth and each hub includes hub uplink bandwidth and hub downlink bandwidth. The allocation of bandwidth among the spokes and hub may be dynamically adjusted based on the present user demands. Additionally, if the communication system is a packet switched system, empty packets may be discarded at the communication platform and the bandwidth that was previously allocated to the packets may be reallocated.

The present invention generally relates to a communication platform such as a satellite system or airborne platform. More particularly, the present invention relates to a communication platform that efficiently allocates communication resources within a hub and spoke network of the communication platform.

A typical satellite communication system includes a satellite that coordinates communications between various points on the earth's surface. Typically, the satellite communications system geographically allocates the earth's surface into a number of circular or hexagonal geographic areas called cells. Each cell is serviced by a different communication channel from the satellite. The communication channel between the satellite and the cell is typically referred to as a spot beam.

Because signals being transmitted at the same frequency interfere with one another, in a typical communications system, spot beams in adjacent cells are operated at different frequencies. Thus, each spot beam is typically surrounded by a number of spot beams operating at different frequencies. The geographic pattern of the frequencies of the spot beams is often referred to as a frequency reuse pattern.

In addition to the satellite, a typical communications system includes hub beams, spot beams (also known as spokes) transmitted from the satellite, and a plurality of user earth terminals within the spot beams. Typical communications system are allocated a fixed amount of bandwidth frequency. For example, a communications system may be allocated a total of 800 MHz of bandwidth frequency. The bandwidth is allocated between uplink and downlink bandwidth. That is, each hub beam is allocated fixed amounts of hub uplink bandwidth and hub downlink bandwidth, while each spoke is allocated fixed amounts of spoke uplink bandwidth and spoke downlink bandwidth. Typically, the bandwidth is allocated evenly between the hub beam and the spot beams, or spokes. That is, the allocation of the aggregate spoke uplink bandwidth, typically equals the allocation of the aggregate hub downlink bandwidth. The even allocation of bandwidth between the spoke uplink bandwidth and hub downlink bandwidth ensures that the peak user uplink demand is satisfied.

Typically, the use of bandwidth within the spot beams, or spokes, fluctuates throughout the day. For example, the amount of bandwidth used in a spot beam on the east coast at 5 A.M. Eastern Standard Time (EST) is typically less than the bandwidth used at 12 P.M. EST. Thus, allocating bandwidth evenly among spokes and hub beams may limit the flexibility of the communications system. That is, statistically, only a portion of the bandwidth allocated to the hub beams is used at any one time.

Further, the bandwidth required to uplink data from a user earth terminal may often remain unused. For example, each user earth terminal may be allocated 5 kHz of bandwidth to uplink data. However, there may be times when only 3 kHz of bandwidth is needed to uplink the data and the remaining 2 kHz of bandwidth remains unused. Thus, the even allocation of bandwidth resources between the uplink and downlink does not take into account usage patterns such as the actual amount of use and the variance in use with the time of day. That is, typical systems evenly allocate bandwidth among hub beams and spokes without taking into account user or service demands. Consequently, bandwidth resources may remain unused or otherwise be wasted.

Therefore, a need has long existed for a more efficient communications system provides increased utilization of the available bandwidth resources.

### SUMMARY OF THE INVENTION

The present invention provides a system and method for allocating uplink and downlink bandwidth resources among the spokes and at least one hub of a satellite or airborne communication platform. The allocation of bandwidth among the spokes and hub may be dynamically adjusted based on the present user demands. Additionally, if the communication platform is a packet switched system, empty packets may be discarded at the satellite and the bandwidth that was previously allocated to the packets may be reallocated.

### BRIEF DESCRIPTION OF THE DRAWINGS

FIG. 1 illustrates a communication platform hub and spoke system according to an embodiment of the present invention.

FIG. 2 illustrates a fixed channelization communication platform according to an embodiment of the present invention.

FIG. 3 illustrates a switching channelization system including a programmable mulitplexer according to an embodiment of the present invention

FIG. 4 illustrates a payload processing system including a packet mulitplexer according to an embodiment of the present invention.

FIG. 5 illustrates a flowchart for determining the BW allocation for the fixed channelization, switching channelization, and packet switching systems according to preferred embodiments of the present invention.

### DETAILED DESCRIPTION OF THE PREFERRED EMBODIMENTS

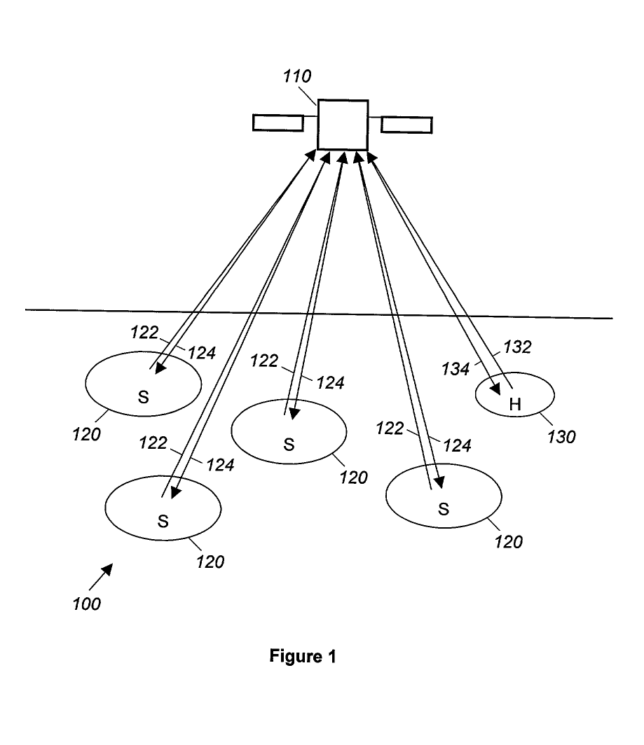

FIG. 1 illustrates a communication platform hub and spoke system 100 according to an embodiment of the present invention. The system 100 includes a communications satellite 110, a plurality of spokes 120, and at least one hub 130. The satellite 110 may alternatively be an airborne platform such as an airplane. For ease of referral, the embodiments below are illustrated as a satellite system, but may also be any airborne platform.

Each spoke 120 may be a geographic area on the surface of the earth in which users may communicate with the satellite 110 through a spoke uplink 122 and a spoke downlink 124. Each spoke 120 may include a plurality of users such as user terminals (not shown), cell phones or computers. The hub is also a geographic area on the surface of the earth in which a hub terminal communicates with the satellite 110 through a hub uplink 132 and a hub downlink 134.

In operation, the user terminals in the spokes 120 communicate with a hub terminal through the satellite 110. That is, a forward hop communication from a hub terminal to a user terminal is sent from the hub terminal to the satellite 110 through the hub uplink 132 and then from the satellite 110 to the user terminal through the spoke downlink 124. The reverse hop communication from the user terminal to the hub terminal is sent from the user terminal to the satellite 110 through the spoke uplink 122 and then from the satellite 110 to the hub terminal through the hub downlink 134.

The satellite 110 includes an internal switch, as further described below. For example, forward hop communication signals received from the hub 130 may be switched by the satellite 110 to any desired spoke 120. Communication signals received at the satellite 110 are typically received at a high frequency (for example, 40 GHz) and are then down converted to an intermediate frequency for switching. The signals may then be switched or routed, using a multiplexer, for example. Once the signals have been correctly switched, the signal is up converted and then transmitted to the spoke 120. Although FIG. 1 includes four spokes, a greater of lesser number of a spokes may be included in the communication system 100.

Although FIG. 1 includes a single hub 130, multiple hubs may be included in the communication system 100. When the communication system 100 includes multiple hubs, the reverse hop from the user terminals to the hubs may also be switched by the satellite as described above with regard to the forward hop. That is, a signal received from a user terminal in a spoke 120 may be downconverted and switched to any of the available hubs and then upconverted and transmitted to the hub.

In the preferred embodiments of the present invention, a fixed amount communication resources (hereafter called bandwidth, abbreviated BW) of the satellite communication system may be allocated to the terminals of the system according to the needs of the terminals rather than according to some non-varying assignment.

The total available BW may be divided into two types of BW, uplink (UL) BW and downlink (DL) BW. These two types of BW are preferably distinct, fixed in amount, and not interchangeable. That is, a fixed amount of UL BW is available for the system, and a fixed amount of DL BW is available for the system. Further, unused UL BW typically may not be used as DL BW, nor may unused DL BW be used as UL BW. However, for both UL and DL BW, portions of the BW may be reused in various spokes or hubs provided the interference generated by the reuse is acceptably small.

In the preferred embodiment of the present invention, there are more UL and DL beams covering user terminals than there are UL and DL beams covering hubs. Thus, at any given time, a plurality of the beams covering user terminals are connected through the satellite to a single beam covering a hub. In more detail, a plurality of UL user terminal spot beams are connected through the satellite to a single DL hub beam. Also, the corresponding hub UL beam is connected through the satellite to the corresponding plurality of user terminal DL beams.

Because a hub communicates with a plurality of user terminals while a user terminal communicates with a single hub, the beam that covers the hub is called a hub beam, in a metaphorical allusion to the hub of a bicycle wheel. At any given time, a user terminal communicates with one and only one hub. However, in a system with a plurality of hubs, a single user terminal may, at different times communicate with different hubs. Continuing the metaphor, since the user terminals communicating with the hub are in a plurality of beams, these beams are called spoke beams. The topology of the network thus includes one or more hubs each connected by the satellite to a plurality of spokes.

In the communication system 100 of FIG. 1, subject to the constraints on BW reuse, such as interference between spokes using the same BW, for example, UL BW and DL BW may be freely allocated among the hub and spokes. Additionally, the more closely BW is allocated to match the actual need for BW, the more efficient is the use of the BW, thus increasing the capacity of the system and providing better quality of service.

In order to maximize the efficiency of the usage of the BW, several constraints are placed on the allocation of the BW among hubs and spokes. First, the allocated UL BW from the spokes need not be equal to the allocated DL BW to the hub. Second, each spoke need not be allocated the same amount of UL BW and DL BW. Third, each hub-and-spoke topology need not have the same total UL BW and same total DL BW as other hub-and-spoke topologies.

Employing these constraints, BW may then be allocated among the hubs and spokes using any of the three principles below, either alone or in combination with each other.

First, the demand for UL BW and DL BW that is required by each of the spokes and the hub is estimated as a function of the Time of Day (ToD). BW is then allocated in proportion to the demand. The allocation of BW is subject to the reuse constraints mentioned earlier. Additionally, the allocation of BW is subject to the granularity into which BW may be subdivided. That is, the total BW is preferably segmented into sections and the sections of BW may be allocated. The sections of BW may be about 10 KHz in size, for example.

The allocation of UL BW is preferably performed separately from the allocation of DL BW. One reason for this is that demand for one of the UL BW and DL BW is typically higher. Because each spoke and hub must support two-directional communication, the results of the UL BW allocation and the DL BW allocation are brought together and resolved so that the total communication capacity of the system is maximized. That is, in order to support communication, a spoke, for example, that is allocated a large amount of DL BW must be allocated at least some UL BW to support two directional communication. Additionally, the spoke is not allocated a disproportionately large amount of BW in one direction (for example, in the DL direction), because then the BW in the other direction (the UL direction) may be insufficient to allow full exploitation of the DL BW. In effect, the excess DL BW is wasted on the spoke. A preferred embodiment of the present invention shifts UL BW and DL BW among the spokes and hubs to meet the communication demands of the spokes and hubs without providing additional communication resources to spokes and hubs which would remain unused and therefore wasted.

Second, in order to allocate the UL BW and DL BW resources, the demand for UL BW and DL BW currently being used by each of the spokes and the hub is measured and analyzed. The BW may be measured, for example, by counting unused BW or segments of BW, or by counting the portion of communications traffic that is dropped at the satellite because of congestion on board the satellite. Additionally, other methods of measuring usage may be employed. The measured usage rates may analyzed by a comparison to a threshold, and averaging process, or some other method to determine whether BW is to be reallocated. When the analysis of the BW usage indicates that BW is to be reallocated, BW is reallocated among the spokes and hubs as described above. That is, preferably UL BW may only be reallocated among hub and spoke uplinks and DL BW may only be reallocated among hub and spoke downlinks.

For example, the analysis may take the form of a comparison against usage thresholds. The usage threshold may be such that each UL or DL is to be allocated 100%-105% of its present measured demand, for example. Additional unused BW may then be reallocated where needed. Alternatively, the threshold may be such that when an UL, for example, is dropping 2-5% of its data traffic at the satellite, then additional BW is allocated to the UL. Additionally, the allocation of BW may include a limitation that the demand of the UL exceeds the available BW for a given duration of time before additional BW is allocated to the UL. The procedures described above may be applied to both UL and DL of both spokes and hubs.

Third, the BW may be reallocated using a linear or integer programming process, a heuristic process or any other technique for optimizing the allocation of resources subject to constraints.

One aspect of the preferred embodiment is the recognition that the sum of the UL BW of the spokes does not need to be equal to the DL BW of the hub. This recognition arises because the UL BW allocated to the user terminals is rarely, if ever, completely used by the user terminals. Thus, the DL BW allocated to the hub to service the UL BW allocated to the user terminals may be less then the UL BW allocated to the user terminals. That is, the portion of the UL BW that is not used does not need to be sent down the hub beam. The satellite payload architecture best suited to take advantage of this inequality is a processing payload. The processing payload may inspect each of the data packets it receives and discard those that are unused. By discarding unused packets rather than sending them down the hub beam, the hub DL BW requirements are lessened, so less hub DL BW is required. The DL BW conserved in this way may be reallocated to spoke DL beams, for example, to increase the capacity of the system.

Additionally, a switching channelization satellite system may also take advantage of unused UL BW in the spokes, as discussed above, provided the system may switch small amounts of BW among the beams. In this case, the architecture of the system that assigns BW to terminals “packs” assignments together in a portion of the BW assigned to user terminals in a spoke. If only a few of the spokes have so much demand that all the allocated BW is occupied with communications, then the switching channelized payload may simply not switch the unused portion of the spokes' UL BW into the hub beam's DL.

The preferred embodiments of the present invention, include a plurality of UL and DL beams. Preferably, there is a one-to-one correspondence between UL and DL beams. That is, for each UL beam there is exactly one DL beam that covers the same region. However, present invention is not limited to a one-to-one-correspondence of DL and UL beams.

Additionally, a single area on the surface of the earth may be covered by more than one UL or DL beam. For example, a region may contain a hub and a plurality of users, and one UL and one DL beam may serve the hub (at one set of frequencies), while another UL and DL beam serves the user terminals (at another set of frequencies). Because communications with the hub occur at different frequencies than communications with the spoke, the communications do not interfere with one another and the location of the hub with regard to the spoke is not limited. That is, the hub may be located outside the spoke, intersecting the spoke, or completely contained within the spoke coverage area.

That is, the hub beam and the spoke beams need not have any geographic relationship in particular. For example, the hub beam and one of the spoke beams may cover the same subregion and the other spoke beams may cover nearby subregions. In this case, the entire region of coverage may be broken down into contiguous areas, where each area has a hub-and-spoke communication topology. Alternatively, the hub beam may be geographically distant from the spoke beams, or no two of these spoke beams may be contiguous to one another. In this case, the entire region may be thought of as being quilted where the disjoint pieces of fabric of the same color are the pieces of a given hub-and-spoke communications topology. Together, all the different colors (i.e., the plurality of hub-and-spoke topologies) make one contiguous quilt, but the colored pieces are not clumped together. In fact, this approach may provide a greater overall system communications capacity than may be obtained with the clumped-together arrangement, as further described below. As another example, the hub beams may be entirely outside the region in which service is being provided to user terminals, so that there is no geographic overlap between the spoke beams and the hub beams. Such an arrangement may reduce the constraints on BW reuse for the spoke beams, and thus increase system communications capacity.

Further, because the hub is a single terminal at a single, precisely defined position, the size of the hub beams may be smaller than the size of the spoke beams to the user terminals. Conversely, because the system may include only a few hubs widely dispersed in geography, the main lobes of the hub beams may be larger than the main lobes of the spoke beams to the user terminals without creating undue interference.

As mentioned above, the hub-and-spoke topology need not require that the hub and spoke beams be contiguous. Instead, the beams may be distributed throughout the overall coverage region. One advantage of such a distributed hub-and-spoke topology is that it provides the ability to take advantage of temporal and geographic fluctuations in ToD demand. ToD demand varies with peaks at some times of the day and dips at other times of the day. Assuming that the region of coverage is large, these ripples in demand are not synchronized across the entire region of coverage. Instead, the demand is dependent on the ToD in the local time zone.

For example, people in the continental U.S. do not all go out to lunch at the same time. For the most part, they are at lunch between noon and 1 PM, local time. When they are at lunch, most of them are not using a data communications system, so demand dips. When they come back from lunch, they check their e-mail or refresh web pages, etc., causing a relative peak in usage between 1 PM and 2 PM.

By arranging the spokes so that peak demand in some spokes coincides with dips in demand in other spokes, a larger number of users may be served with the same amount of resources. That is, relatively more BW may be assigned to the spokes that currently have a peak in demand, and at the same time relatively less BW may be assigned to the spokes that currently have a dip in demand. The demand may be determined and BW may be allocated using the techniques described above. Additionally, because the variance of demand with ToD is substantially consistent, the BW may be allocated without an actual measurement of the BW demand. The BW may simple be allocated based on the ToD and an a priori assumption about traffic demand.

Thus, as described above, the data traffic is measured or a priori assumptions about the traffic are made. In either case, spoke beam UL and DL BW may be allocated and hub beam UL and DL BW may be allocated based on actual or imputed traffic to best match the demands made by the traffic. Preferably, to determine the best match, the BW is allocated in proportion to the traffic demand subject to the reuse constraints and the granularity into which BW may be subdivided, as discussed above.

Although BW is preferably allocated in proportion to the traffic demand, the allocation need not be proportional. For example, other traffic engineering considerations, such as the need to provide a higher quality of service to specific hubs or to a subset of the users, may cause the system to allocate a disproportionately larger or smaller share of the BW to some beams.

In addition to the measurement of traffic or the a priori assumptions about the traffic, the allocation of DL BW to the hub beam may be influenced by measurements or assumptions about how much spoke UL BW remains unused. For example, if the satellite payload discards unused packets received from the user terminal UL, then the allocated DL BW for a hub beam may be less than the sum of the allocated UL BW, as further described below. In order to ensure that the peak user demand was satisfied, prior systems matched the amount of spoke UL BW to the hub DL BW. Statistically, however, hub DL typically requires less BW than the spoke UL because the total spoke UL BW is rarely completely used.

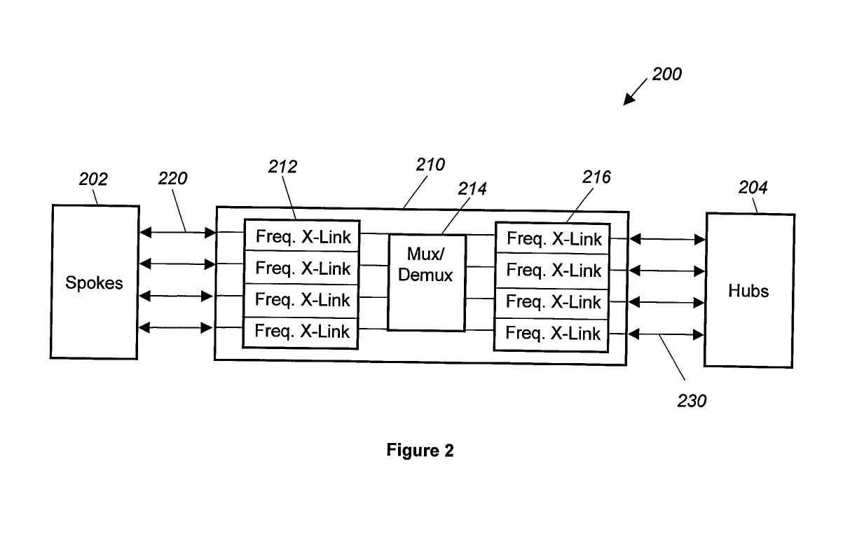

FIG. 2 illustrates a fixed channelization communication platform 200 according to an embodiment of the present invention. The fixed channelization communication platform 200 includes spokes 202, at least one hub 204, and a satellite 210. The spokes 202 communicate with the satellite 210 through spoke UL/DL beams 220. The hubs 204 communicate with the satellite 210 through hub UL/DL beams 230. The satellite 210 includes spoke frequency cross links 212, hub frequency cross links 216, and a switching multiplexer 214.

The satellite system operates as described above. A user terminal within a spoke 202 uplinks a signal to the satellite 210 where the signal is received and sent to a spoke frequency cross link 212. The spoke frequency cross-link 212 down-converts the signal to an intermediate frequency and passes the signal to the multiplexer 214. The multiplexer 214 routes or switches the signal to the desired hub frequency cross link 216 serving the desired transmit hub. The hub frequency cross link 216 then upconverts the signal and transmits the signal to the hub 204. The reverse path from the hub to the user terminal proceeds similarly.

In the fixed channelization communication platform 200, the channelization is optimized using one of the preferred embodiments of the present invention, but is fixed and not adjustable. That is, the hub UL BW, hub DL BW, spoke UL BW, and spoke DL BW have been re-allocated as discussed above, and are fixed in their allocation.

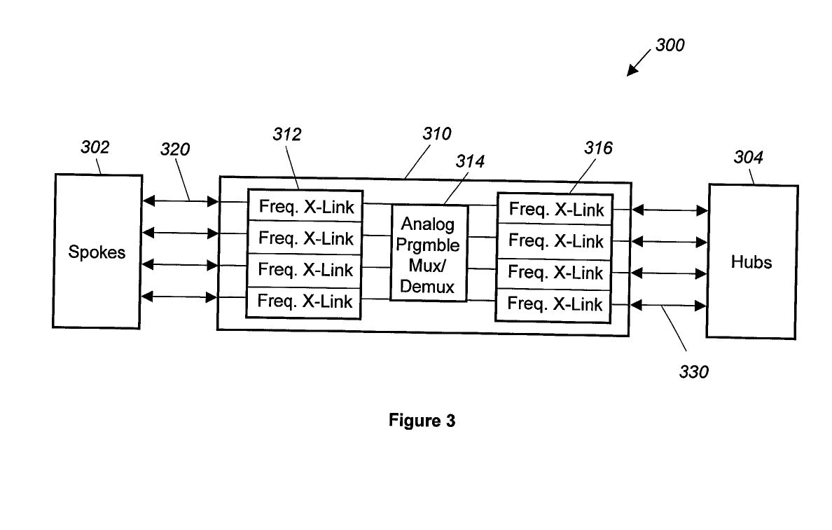

FIG. 3 illustrates a switching channelization satellite system 300 including a programmable mulitplexer according to an embodiment of the present invention. Similar to the satellite system in FIG. 2, above, the satellite system 300 includes spokes 302, hubs 304, a satellite 310, spoke UL/DL beams 320, hub UL/DL beams 330, spoke frequency cross links 312, and hub frequency cross links 316. The main difference between the system 200 of FIG. 2 and the system 300 of FIG. 3 is the addition of an analog programmable multiplexer 314 in the system 300 of FIG. 3.

As opposed to the fixed channelization system 200 of FIG. 2, in the switching channelization system 300, as mentioned above, the user demand for each hub UL, hub DL, spoke UL and spoke DL is monitored. Alternatively, the signal traffic drop rate at the satellite for each UL and DL may be monitored. The user demand or signal traffic drop rate is compared to a model as discussed above and the BW allocation to the hub and spoke UL and DL are adjusted in accordance with the model. Alternatively, the BW may be reallocated automatically based on a predetermined model of data traffic without directly measuring the data traffic.

Additionally, the analog programmable multiplexer 314 allows the system 300 to be programmed for automatic control. That is, although the multiplexer 314 of the may be externally monitored and controlled from a ground-based control station, for example, the analog programmable multiplexer 314 may be programmed to control the BW allocation of the system 300 automatically. For example, the analog programmable multiplexer 314 may be programmed to vary the BW allocation of the system with the Time of Day (ToD) in accordance with the factors discussed above.

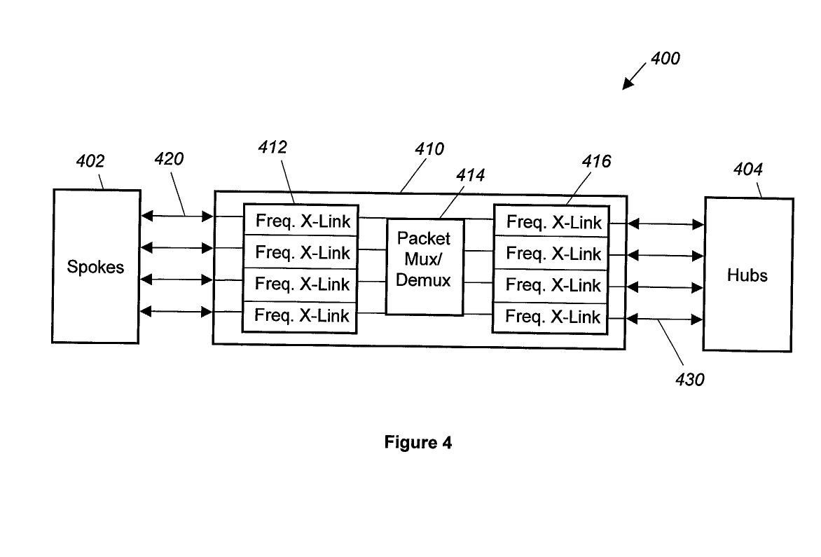

FIG. 4 illustrates a payload processing satellite system 400 including a packet mulitplexer according to an embodiment of the present invention. Similar to the satellite system in FIGS. 2 and 3, above, the satellite system 400 includes spokes 402, hubs 404, a satellite 410, spoke UL/DL beams 420, hub UL/DL beams 430, spoke frequency cross links 412, and hub frequency cross links 416. The main difference between the system 400 of FIG. 4 and the previous systems is that the system 400 is a packet switching system and includes a packet multiplexer 414.

The addition of the packet multiplexer 414 allows the allocation of BW to be further optimized because packets that do not contain data may be dropped at the satellite. For example, a spoke 402 may include a number of users. Each user is typically allocated a certain portion of the total available UL and DL bandwidth for the hub. If the user is using a cell phone, for example, there may be period of time during which the user is silent (listening to received conversation) during this period, the packets sent from the user's cell phone to the satellite 410 do not include data and may be discarded at the satellite 410. Because the packets have been discarded at the satellite 410 the hub DL BW that would typically be required to downlink the discarded packets to the hub 404 is no longer needed and the hub DL BW may be reallocated. Alternatively, instead of using none of the available UL or DL bandwidth, the user may only be using a portion of the total UL or DL BW available to them. The packet multiplexer 414 may then reallocate the unused portions of BW.

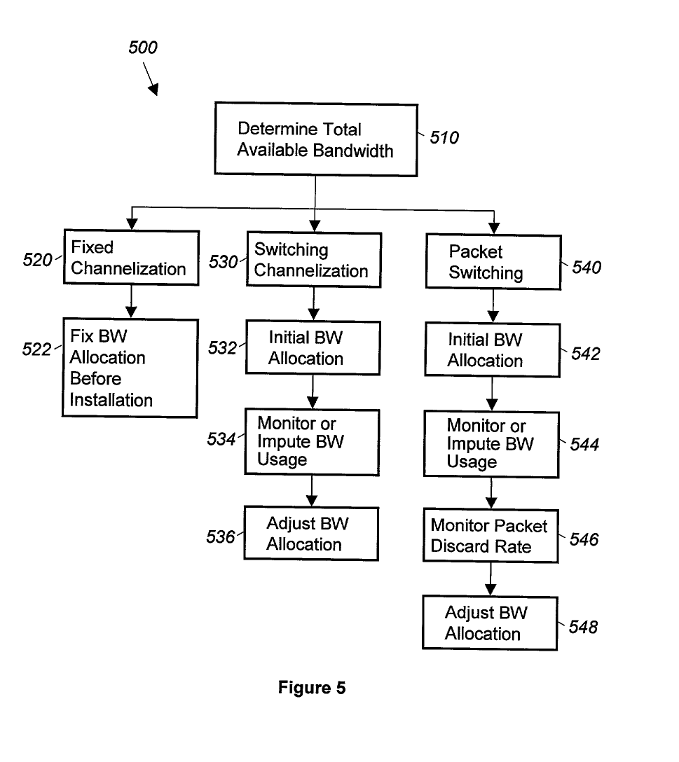

FIG. 5 illustrates a flowchart 500 for determining the BW allocation for the fixed channelization, switching channelization, and packet switching satellite systems according to preferred embodiments of the present invention. First, at step 510, the total available BW for the satellite system is determined. The satellite system may be one of three types; fixed channelization, switching channelization, and packet switching.

The fixed channelization system is presented at step 520. For the fixed channelization system, the total available BW is allocated among hub and spoke UL and DL, for example according to statistical user demand. The BW allocation is fixed and the satellite system is installed.

The switching channelization system is presented at step 530. First, at step 532, an initial BW allocation may be determined similar to the BW allocation of the fixed channelization system. However, once the switching channelization system is installed, the system monitors BW usage or user demand or alternatively imputes BW usage or user demand, for example according to ToD, at step 534. The system may then dynamically adjust the BW allocation based on the actual user demand at step 536.

The packet switching system is presented at step 540. First, at step 542, an initial BW allocation is determined similar to the BW allocaiton of the fixed and switching channelization systems. Similar to the switching channelization system, once installed, the packet switching system monitors the BW usage or alternatively imputes BW usage or user demand, for example according to ToD, at step 544. Additionally, the packet switching system optionally monitors the packet discard rate at the satellite and the corresponding effect on BW usage at step 546. Finally, at step 548, the system dynamically adjusts the BW allocation based on the user demand and optionally based on the packet discard rate.

While particular elements, embodiments and applications of the present invention have been shown and described, it is understood that the invention is not limited thereto since modifications may be made by those skilled in the art, particularly in light of the foregoing teaching. It is therefore contemplated by the appended claims to cover such modifications and incorporate those features that come within the spirit and scope of the invention.

What is claimed is:

1. A communication platform allocating bandwidth among spokes and hub beams based on user demand including:
a communication platform;
a hub beam, said hub beam allocated hub uplink bandwidth and hub downlink bandwidth; and
a plurality of spokes, each spoke allocated spoke uplink bandwidth and spoke downlink bandwidth,
wherein the sum of said spoke uplink bandwidth allocated among said plurality of spokes differs from said hub downlink bandwidth allocated to said hub beam.

2. The communication platform of claim 1 wherein said sum of spoke uplink bandwidth is greater than said hub downlink bandwidth.

3. The communication platform of claim 1 wherein at least one of said spokes is allocated differing amounts of spoke uplink bandwidth and spoke downlink bandwidth.

4. The communication platform of claim 1 wherein said communication platform dynamically re-allocates uplink bandwidth between said hub uplink bandwith and said spoke uplink bandwidth.

5. The communication platform of claim 1 wherein said communication platform dynamically re-allocates said spoke downlink bandwidth and said hub downlink bandwidth among said spokes and said hub beam at different times of day.

6. The communication platform of claim 1 further including user terminals located within said spokes, wherein said communication platform includes a processor, said processor receives data packets from said user terminals and reserves unused data packets as unused spoke and hub uplink bandwidth.

7. The communication platform of claim 6 wherein said processor re-allocates said unused spoke and hub uplink bandwidth among said spokes and said hub.

8. A switching system for a communication platform including a plurality of spokes and at least one hub, said switching system including:
a multiplexer allocating bandwidth among a plurality of spokes and at least one hub based on user demand.

9. The switching system of claim 8 wherein said spokes include spoke uplink bandwidth and said at least one hub includes hub downlink bandwidth and the sum of said spoke uplink bandwidth differs from said hub downlink bandwidth.

10. The switching system of claim 9 wherein the sum of said spoke uplink bandwidth is greater than said hub downlink bandwidth.

11. The switching system of claim 8 wherein said spokes include spoke downlink bandwidth and said at least one hub includes hub uplink bandwidth and the sum of said spoke downlink bandwidth differs from said hub uplink bandwidth.

12. The switching system of claim 11 wherein the sum of said spoke downlink bandwidth is less than said hub uplink bandwidth.

13. A method for dynamically reassigning communication resources of a communication system, said communication system including a communication platform, at least one hub, and a plurality of spokes, said method including the steps of:
determining a service demand for said plurality of spokes;
allocating uplink bandwidth among said plurality of spokes and said at least one hub based on said service demands; and
allocating downlink bandwidth among said plurality of spokes and said at least one hub based on said service demands.

14. The method of claim 13 further including the step of:
switching between a first uplink bandwidth allocation and a second uplink bandwidth allocation based on changes in said service demands; and
switching between a first downlink bandwidth allocated and a second downlink bandwidth allocated based on changes in said service demands.

15. The method of claim 13 wherein said spokes include spoke uplink bandwidth and said at least one hub includes hub downlink bandwidth and the sum of said spoke uplink bandwidth differs from said hub downlink bandwidth.

16. The method of claim 15 wherein the sum of said spoke uplink bandwidth is greater than said hub downlink bandwidth.

17. The method of claim 13 wherein said spokes include spoke downlink bandwidth and said at least one hub includes hub uplink bandwidth and the sum of said spoke downlink bandwidth differs from said hub uplink bandwidth.

18. The method of claim 17 wherein the sum of said spoke downlink bandwidth is less than said hub uplink bandwidth.

19. The method of claim 13 wherein the allocation of at least one of uplink bandwidth and downlink bandwidth differs for at least one spoke.
